(19) United States
(12) Patent Application Publication
(10) Pub. No.: US 2025/0166076 A1
(43) Pub. Date: May 22, 2025

(54) METHODS AND SYSTEMS TO QUANTIFY AND INDEX LIQUIDITY RISK IN FINANCIAL MARKETS AND RISK MANAGEMENT CONTRACTS THEREON

(71) Applicant: ECONOMIC ALCHEMY INC., New York, NY (US)

(72) Inventors: Giselle Claudette Guzman, New York, NY (US); Lawrence Klein, GIadwyne, PA (US)

(21) Appl. No.: 19/030,586

(22) Filed: Jan. 17, 2025

Related U.S. Application Data
(62) Division of application No. 18/388,764, filed on Nov. 10, 2023.
Application No. 18/388,764 is a continuation of application No. 17/962,395, filed on Oct. 7, 2022, now Pat. No. 11,854,083.
Application No. 17/962,395 is a continuation of application No. 16/910,028, filed on Jun. 23, 2020, now Pat. No. 11,551,305.
Application No. 16/910,028 is a continuation of application No. 13/677,277, filed on Nov. 14, 2012, now abandoned.
(60) Provisional application No. 61/629,227, filed on Nov. 14, 2011.

(51) Int. Cl. G06Q 40/06

(52) U.S. Cl. CPC G06Q 40/06

(57) ABSTRACT

Systems and methods for creating indicators to quantify and index financial market liquidity risk that is marked wide among a broad set of securities or asset classes or portfolio specific relative to an individual investor's portfolio holdings. A liquidity risk index can be created as a counterpart to any well-known market index, such as the Dow Jones Industrial Average® or the S&P 500® index. The present disclosure relates to risk management in financial markets and in particular to systems and methods for quantifying and indexing liquidity risk such that these indices can serve as underlying assets for futures, options, or other financial instruments that investors would use to hedge against the liquidity risk.

### CROSS-REFERENCE TO RELATED APPLICATIONS

This application is a divisional of U.S. patent application Ser. No. 18/388,764, filed on Nov. 10, 2023, which is a continuation of U.S. patent application Ser. No. 17/962,395, filed Oct. 7, 2022, which is a continuation of U.S. patent application Ser. No. 16/910,028, filed Jun. 23, 2020 (now U.S. Pat. No. 11,551,305), which claims the benefit of U.S. patent application Ser. No. 13/677,277, filed Nov. 14, 2012, which claims the benefit of U.S. Provisional Patent Application No. 61/629,227, filed Nov. 14, 2011, the contents of which are incorporated by reference herein in their entireties.

This application is also related to U.S. patent application Ser. No. 13/677,273, entitled “METHODS AND SYSTEMS TO CREATE SYNTHETIC VARIABLES, INDICATORS AND INDICES FROM MULTIPLE DATA AND METADATA SOURCES AND RISK MANAGEMENT CONTRACTS THEREON,” U.S. patent application Ser. No. 13/677,276, entitled “METHODS AND SYSTEMS TO EXTRACT SIGNALS FROM LARGE AND IMPERFECT DATA SETS,” U.S. patent application Ser. No. 13/677,278, entitled “METHODS AND SYSTEMS TO QUANTIFY AND INDEX CORRELATION RISK IN FINANCIAL MARKETS AND RISK MANAGEMENT CONTRACTS THEREON,” and U.S. patent application Ser. No. 13/677,297, entitled “METHODS AND SYSTEMS TO QUANTIFY AND INDEX SENTIMENT RISK IN FINANCIAL MARKETS AND RISK MANAGEMENT CONTRACTS THEREON,” all of which were filed on Nov. 14, 2012 and are incorporated by reference herein in their entireties.

### TECHNICAL FIELD

The present disclosure relates to risk management in financial markets, and in particular to systems and methods for quantifying and indexing risks such that these indices can serve as underlying assets for futures and options and other financial instruments that investors would use to hedge against the risks.

### BACKGROUND

Markets are incomplete, in that, it is not possible to hedge against all potential risks. Recent financial crises have highlighted the need for more effective risk management. Portfolio managers are increasingly faced with the need to better understand and efficiently manage multiple sources of risk that can affect the value of their holdings. This can be particularly challenging for holders of multiple asset classes across multiple geographies. Some customized hedging solutions are available to professional money managers, such as, for example the use of swaps. But these over-the-counter instruments are unregulated, expensive, illiquid, and carry significant counter-party risk. The over-the-counter swaps market operates in the shadows of the financial markets, with an estimated size of $650 billion. (See, e.g., huffingtonpost.com/2012/07/08/us-derivatives-reform-rules_n_1656980.html, which is hereby incorporated by reference herein in its entirety.) Indeed, the lack of transparency in the swaps market is largely blamed in the collapse of financial firms such as Lehman Brothers and insurer American International Group during the financial crisis of 2007-2009, which led to billions of dollars in government bailouts, a burden ultimately shouldered by taxpayers.

The specter of regulation looms over the derivatives market. The 2010 Dodd Frank financial reform law is meant to increase transparency in order to mitigate systemic risk, but compliance with such regulation will be expensive, and many small traders will be likely shut out of the market. Additionally, customized and complex hedging solutions through the use of swaps and other derivatives have long been out of reach for individual investors, and costly regulation will further prohibit individual investors from being able to hedge their portfolios from serious risks that can devastate the value of their portfolios. Recent decades have brought technological advances that democratized equity trading for individual investors by making online trading accessible and affordable, but effective risk management remains out of reach.

Risk management must be simplified and democratized in order to build and preserve wealth, both for institutions as well as for individuals. Risk metrics and risk management contracts must be accessible, affordable, and transparent. Improved risk management techniques will assist in mitigating the boom-bubble-bust cycles that have roiled financial markets in recent decades.

One example of improvement in risk management techniques was the introduction of the Chicago Board Options Exchange Market Volatility Index®, also known by its ticker symbol, “VIX”. The VIX is a popular measure of the implied volatility of S&P 500® index options. It is often referred to as the fear index or the fear gauge, because it represents one measure of the market's expectation of stock market volatility over the subsequent 30-day period. The concept of a volatility index, and financial instruments based on such an index, was first proposed by Menachem Brenner and Dan Galai in 1986, and was published in “New Financial Instruments for Hedging Changes in Volatility,” appearing in the July/August 1989 issue of Financial Analysts Journal. (See, e.g., people.stern.nyu.edu/mbrenner/research/FAJ_articleon_Volatility_Der.pdf, which is hereby incorporated by reference herein in its entirety.)

While stock index options and futures give investors the ability to hedge against market and interest rate volatility, the VIX allows investors to hedge against the risk of changes in volatility. Changes in market volatility can be brought about by macroeconomic factors such as inflation or economic policy, or by firm-specific factors such as changes in capital structure or news about performance.

The ability to hedge against changes in volatility has helped to complete the market by providing insurance against a very real and potentially devastating portfolio risk.

But markets remain significantly incomplete. Investors today are faced with a multitude of serious risks that remain uninsurable. These risks are frequently discussed by market practitioners and in the financial media, but they are discussed as broad concepts, often in nebulous terms. As of yet, there has not been a concerted effort to quantify and index many of these risks so that efficient and accessible hedging methods can be introduced.

There are three risks that are of particular and vital importance to investors participating in modern financial markets: 1) correlation risk; 2) liquidity risk; and 3) sentiment risk. We propose systems and methods to quantify and index these risks, and risk management contracts in order to insure against these risks. These indices would serve as underlying assets for futures and options and other financial instruments that investors would use to hedge against the risk of changes in correlation, liquidity, and sentiment in financial markets.

### BRIEF DESCRIPTION OF THE DRAWINGS

FIG. 1 illustrates an example network environment in which various exemplary embodiments of the present disclosure can operate;

FIG. 2 is a schematic diagram illustrating the creation of a Liquidity Risk Index; and

FIG. 3 depicts an exemplary graphical display of a Liquidity Risk Index.

### SUMMARY

Systems and methods for creating indicators to quantify and index financial market liquidity risk that is market-wide among a broad set of securities or asset classes or portfolio specific relative to an individual investor's portfolio holdings. A liquidity risk index can be created as a counterpart to any well-known market index, such as the Dow Jones Industrial Average® or the S&P 500® index. The present disclosure relates to risk management in financial markets, and in particular to systems and methods for quantifying and indexing liquidity risk such that these indices can serve as underlying assets for futures and options and other financial instruments that investors would use to hedge against the risks.

In accordance with some embodiments, a method for providing a risk index is provided, the method comprising: selecting a plurality of assets; retrieving financial data associated with each of the plurality of assets; determining a liquidity risk measurement corresponding to each of the plurality of assets based in part on the retrieved financial data; generating a plurality of composite liquidity risk measurements by applying each of a first set of weights associated with each of the plurality of assets to a corresponding liquidity risk measurement; aggregating the plurality of composite liquidity risk measurements for each of the plurality of assets to generate a liquidity risk index, wherein a second set of weights are selected from an identified index and wherein each of the second set of weights is applied to each of the plurality of composite liquidity risk measurements; and providing the liquidity risk index.

In accordance with some embodiments, a system for providing a risk index is provided, the system comprising a hardware processor that is configured to: select a plurality of assets; retrieve financial data associated with each of the plurality of assets; determine a liquidity risk measurement corresponding to each of the plurality of assets based in part on the retrieved financial data; generate a plurality of composite liquidity risk measurements by applying each of a first set of weights associated with each of the plurality of assets to a corresponding liquidity risk measurement; aggregate the plurality of composite liquidity risk measurements for each of the plurality of assets to generate a liquidity risk index, wherein a second set of weights are selected from an identified index and wherein each of the second set of weights is applied to each of the plurality of composite liquidity risk measurements; and provide the liquidity risk index.

In accordance with some embodiments, a non-transitory computer-readable medium containing computer-executable instructions that, when executed by a processor, cause the processor to perform a method for providing a risk index, is provided. The method comprising: selecting a plurality of assets; retrieving financial data associated with each of the plurality of assets; determining a liquidity risk measurement corresponding to each of the plurality of assets based in part on the retrieved financial data; generating a plurality of composite liquidity risk measurements by applying each of a first set of weights associated with each of the plurality of assets to a corresponding liquidity risk measurement; aggregating the plurality of composite liquidity risk measurements for each of the plurality of assets to generate a liquidity risk index, wherein a second set of weights are selected from an identified index and wherein each of the second set of weights is applied to each of the plurality of composite liquidity risk measurements; and providing the liquidity risk index.

In some embodiments, the method further comprises converting single or composite liquidity measures to an index.

In some embodiments, the method further comprises obtaining a composite measure by combining single measures by arbitrary weights or optimization or signal extraction method.

In some embodiments, multiple optimization or signal extraction methods are used simultaneously to choose the one that results in the lowest error or most predictive power.

In some embodiments, the method further comprises generating an alerts (e.g., text, visual, auditory, or graphical) when liquidity risk surpasses some pre-specified user-defined level or is abnormally high or low, and a scrolling ticker of values, levels, or changes (numerical or percent).

In some embodiments, the method further comprises generating analytical displays, graphs, GUIs, comparisons, trends over time, increasing, decreasing, forecasted price impact, predictive power, trade recommendations to change liquidity risk profile of a portfolio or take advantage of changing liquidity conditions in the market.

In some embodiments, the method further comprises generating a liquidity arbitrage alert for liquidity differences of securities that trade in multiple markets.

In some embodiments, the method further comprises connecting to portfolio holding data from an online brokerage account or other source to provide customized a liquidity risk measure for individual portfolio or user can input manually. In the case of a customized liquidity risk index for individual portfolio holdings, it is noted that portfolio weights must be applied, wherein the portfolio weights represent the percentage composition of a particular holding in a portfolio. Portfolio weights can be simply calculated using different approaches: the most basic type of weight is determined by dividing the dollar value of a security by the total dollar value of the portfolio. Another approach would be to divide the number of units of a given security by the total number of shares held in the portfolio.

In some embodiments, the liquidity metric can be price-based, volume-based, or time-based, or some combination of the three, whereby a composite measure is formed by assigning weights, such weights assigned arbitrarily or obtained by some optimization or signal extraction method, such as principal components analysis, whereby such signal extraction is performed in a rolling or recursive fashion in order to obtain a time series of eigenvector loadings, and further where the composite (or single) liquidity measure is then indexed and weighted to conform with some well-known index, e.g., the index weightings reflect the same weighting methodology as an index such as the S&P500®, DJIA®, etc.

In some embodiments, the method further comprises displaying the information to a user in a graphical user interface (GUI).

In some embodiments, the method further comprises generating real-time alerts regarding current or future economic or financial conditions, quantities or states, or asset prices or when the liquidity risk surpasses a defined threshold level.

In some embodiments, the defined threshold level is 5% greater than, or some other quantity.

In some embodiments, the real-time alerts are based on user-configurable conditions or parameters including one or more of: abnormally positive, abnormally negative, changes liquidity conditions above or below a pre-selected threshold, abnormally high volume, abnormally low volume, social media posts to certain websites regarding companies and their financial prospects or their stock prices or the liquidity thereof, social media posts containing certain keywords or metadata tags, and volume of Internet search queries regarding liquidity.

In some embodiments, the harvesting includes using a conversation monitoring module to collect web content to generate a real-time database of social media and web conversations related to current or future economic or financial conditions, quantities or states, or asset prices.

In some embodiments, the conversation monitoring module utilizes a web crawler.

In some embodiments, a system for analyzing social media postings on the Internet, the system comprising: a conversation monitoring module, said module having an associated web crawler, wherein, in operation, said module generates a conversation index of social media data related to liquidity conditions or current or future economic or financial conditions, quantities or states, or asset prices.

In some embodiments, the method further comprises determining how liquidity risk or financial conditions, quantities or states, or asset prices (i) trends over time, (ii) varies by source or group of sources, and/or (iii) concurrently trends over time and varies by source.

In some embodiments, the method further comprises comparing liquidity risk of a market-wide index or individual portfolio to historical returns, volume, prices, other risks such as correlation, sentiment, volatility, trends over time, visualizations, statistical analyses.

In some embodiments, the method further comprises a graphical user interface that allows a user to configure parameters, such as a wizard which prompts the user to set parameters by which the system calculates, delivers, and displays a liquidity metric for such a user-configurable measure.

In some embodiments, the method further comprises determining the moments of the liquidity metric's data series, wherein such calculations determine the statistical properties of the data, comprising one or more of the: (i) mean, (ii) median, (iii) mode, (iv) variance, (v) standard deviation, (vi) kurtosis, or (vii) skewness, and/or using these as elements of the metric.

In some embodiments, the method further comprises calculating the statistical relationships between data items, comprising one or more of the liquidity metrics (i) correlation, (ii) cointegration, or (iii) covariance, and using these as elements of the metric.

In some embodiments, a method of creating an indicator of liquidity risk is provided, the method comprising: selecting N assets; obtaining trade and quote data for each asset comprising of a bid price, an ask price, and transaction prices and volume; calculating a measure of liquidity risk for each asset of interest by determining the spread (ask price—bid price) and dividing the spread by the last transaction price; optionally weighting the liquidity measure by volume of shares transacted; forming a composite liquidity risk index by applying weights to then liquidity measures to form a composite index, wherein said weights are determined either arbitrarily or by using a signal extraction algorithm and weights have value between −1 and 1, inclusive, and collectively sum to a fixed number, for example the number 1; aggregating liquidity measures across securities and applying methodology and weightings that correspond to the security's weight in an index (such as the stock's weighting in the S&P 500®).

In some embodiments, a method of hedging liquidity risk is provided, the method comprising: issuing derivatives—options, futures, or options on futures—or an Exchange Traded Fund or an Exchange Traded Note or some other financial instrument to track the value of the composite liquidity risk index; and issuing derivatives or some other financial instruments to track the value of each of the underlying liquidity measure;

wherein as the price of each underlying derivative contract on liquidity changes, the price of the composite index changes in real time as the price of each underlying liquidity measure changes.

In some embodiments, a method of comparing liquidity risk measures and evaluating liquidity risk as predictor of future returns using statistical analyses and/or econometric models, such as OLS, MLE, GMM, and Granger Causality, for example.

### DETAILED DESCRIPTION

### A. Overview

In exemplary embodiments of the present disclosure, systems and methods for creating a liquidity risk index measuring market-wide liquidity of securities in a financial market or an individual portfolio of assets are presented.

The present disclosure concerns market liquidity risk, i.e., the risk that price conditions worsen when one needs to unwind a position. The term liquidity refers to different aspects of markets, such as price impact, time-to-fill, and probability of fill of various orders. Generally, liquidity means an ability to quickly trade stocks or other securities without causing a significant impact on the price.

Market Liquidity is low—i.e., liquidity risk is high—when it is difficult to raise money by selling an asset, that is, when the act of selling depresses the sale price.

Although the term liquidity is widely used in finance literatures, its meaning is loosely defined and there is no one quantitative measure for it, and no way to hedge against it.

There are three generally accepted notions of liquidity:
1) Price-based Measures: transaction costs, typically measured by the Bid-Ask spread, measure how much it will cost a trader to sell an asset and buy it back right away. The lower the bid-ask spread, the more liquid is the security.
2) Volume-based Measures: also known as market depth, measures how many units traders can sell or buy at the current bid or ask price without impacting the price
3) Time-based Measures: also known as market resiliency, measures how long it takes for prices that have fallen to bounce back

Liquidity decreases (or alternatively, liquidity risk increases) in times of turmoil. Therefore, liquidity risk is an important factor affecting portfolio returns. There is currently no way to hedge liquidity risk and insure a portfolio against losses due to adverse market liquidity conditions.

One solution to this problem is to create an index that measures and tracks liquidity for a collection of securities or assets. Such an index can be generalized to track the state of market-wide liquidity for a well-known index, such as the liquidity for the S&P500® or the Dow Jones Industrial Average® index for example. Similarly, such an index can be highly specialized and customized to track individual portfolio holdings, such as the liquidity of individual stocks, ETFs, particular issues of bonds, commodities, options with particular strike prices or expiration dates, and so on.

The indicators can be constructed using price and trade indication data on securities, from which a liquidity measure is calculated in real-time.

Similarly, such an index can be constructed using other data, such as volume. An index can be constructed using either a singular liquidity measure or a composite liquidity measure applied to securities whereby the composite measure is obtained by applying arbitrary weights or obtaining the weights through optimization or signal extraction methods such as rolling or recursive Principal Components Analysis or another signal extraction method whereby the weights range in value between −1 and 1, inclusively, and collectively sum to a fixed number, and then the liquidity measures for different securities are aggregated and converted to an index using (i) a simple method, such as, for example, a weighted average whereby the weights can be arbitrarily assigned, or weighted by applying a pre-defined weighting scheme which mimics index weights of a well-known index such as the market-capitalization weights that are applied to the S&P 500®, or by summing and applying a divisor such as the method used to calculate the Dow-Jones Industrial Average®, or by (ii) mathematical formulae, transformations, statistical formulae, or some algorithmic method, or (iii) customized to measure the level of liquidity risk of a particular portfolio of individual holdings of various securities wherein portfolio weights are applied, or (iv) the liquidity risk for a particular individual security.

The term “data” as used herein includes transaction data, such as price, volume, and bid and ask quotes, and also includes (i) the moments of the statistical distribution of the data, such as, for example, the mean, standard deviation, variance, standard deviation, kurtosis, and skewness; (ii) statistical measures of the data, such as the median and mode; (iii) transformations such as, for example, arithmetic or logarithmic; or (iv) properties of the data over time, such as, for example, a moving average. It is also understood that the term “data” further includes various statistical relationships amongst the various sources of data, such as, for example, correlations, cointegrations, and covariances. The term data as used herein also includes transaction data such volume, volume-weighted average price, trade indication data such as bid price, ask price, and size, market depth, and technical analysis data such as relative strength indicators (RSI), moneyflow, and other price and volume data.

In exemplary embodiments of the present disclosure, once generated as described herein, such indicators can be used to identify and quantify liquidity risk in financial markets. In this case, the indicator becomes an index, whose value is calculated and changes in real time. Thus, financial instruments—i.e., risk management contracts in the form of futures, options, and options on futures or Exchange Traded Funds (ETFs) or other financial instruments-can be introduced which track the value of such an index. This can provide financial market participants with a method of hedging liquidity risk, which is currently neither quantified nor hedgeable.

Data, such as securities prices, volume, and quotes (bid and ask prices) and other data can be obtained from stock exchanges, or any number of sources including:
IHS Global Insight®, Bloomberg®, Reuters®, Capital IQ®, CME Group COMEX®, S&P Capital IQ®, Chicago Board of Trade®, Chicago Board of Options Exchange®, TAO® Trade and Quote Data, NYMEX®, Standard & Poors®, NYSE® Euronext, NASDAQ®, or similar sources.

In exemplary embodiments of the present disclosure, an indicator can be statistically tested in an econometric model against historical price or return data in order to make a parameter estimate of the liquidity risk factor that can then be used to generate a forecast of expected returns. In the case of stock prices, a liquidity risk indicator can be tested against aggregate or cross-sectional returns to determine if liquidity risk is a factor that is priced in the market. A similar analysis can be done for aggregate returns in the case of bonds, commodities, currencies, or any other asset class.

In exemplary embodiments of the present disclosure an exemplary indicator can be tested against historical data of outcomes by means of (i) a simple statistical analysis, such as correlation or covariance, or by (ii) an econometric model such as Ordinary Least Squares, specified by (y=a+bx+e) whereby the indicator would obtain associated parameter estimates, such as Alpha (a, a constant), Beta (b, the covariance between x and y divided by the variance of x), the Error (e), sigma (the standard deviation of x) and sigma-squared (the variance of x). Other methods to estimate an econometric model can include, for example, General Method of Moments, Maximum Likelihood Estimate, etc. An indicator can be modeled either linearly or non-linearly. It is recognized that in several instances the data may be of different sampling frequencies, so that either the data must be converted to the same frequency, or a technique for modeling mixed frequency data must be employed such as, for example, a MIDAS (Mixed Data Sampling) regression. Tests of bilateral feedback can be conducted via Granger Causality tests.

In exemplary embodiments of the present disclosure, indicators can be made available on a platform which allows users to (i) specify data inputs for creating custom indicators, i.e., to construct a customized Liquidity Risk Indicator for their specific portfolio by manually inputting information about their portfolio holdings or connecting to such information provided by an online brokerage account, (ii) apply a mathematical formula, statistical method, or signal extraction algorithm to calculate the indicator from one or various liquidity measures, and then aggregating to form the liquidity risk index, (iii) test the index against actual outcomes and historical data, (iv) make forecasts of future portfolio returns, and, (v) the system can generate trade recommendations to improve the liquidity risk profile of their portfolio. The indicators can be displayed numerically, or in graphical form, and can, for example, be compared to one another, displayed in real-time or as time series historical data, and/or compared to other historical data. In exemplary embodiments of the present disclosure such indicators can be used to forecast future outcomes and predict future values of various economic or financial conditions, quantities, or states, or asset prices.

Thus, various exemplary embodiments of the present disclosure can include one or more of the following processes, systems or methods:
1) The use of securities prices, transaction data, quote and trade indication data, volume data, asset prices and other data to make indicators regarding current and/or future liquidity risks of financial markets, individual portfolios, economic or financial conditions, quantities or states, or asset prices;
2) Using one or combining several of these indicators to create a composite indicator of current and/or future liquidity risks of financial markets, individual portfolios, economic or financial conditions, quantities or states, or asset prices; in such combinations the combination weights can be determined either arbitrarily or by applying an optimization or signal extraction algorithm such as rolling or recursive Principal Components Analysis whereby such weights can range in value between −1 and 1, inclusive, and collectively sum to a fixed number. (See, e.g., Hotelling, H. (1933), “Analysis of a complex of statistical variables into principal components,” Journal of Educational Psychology 24, 417-441,498-520, which is hereby incorporated by reference herein in its entirety.)
3) Creation of liquidity risk index based on the liquidity risk measures, such index created by aggregating across securities and applying methodology and index weights to mirror a well-known financial market index, or alternatively, creating a customized liquidity risk index for an individual portfolio of various assets.
4) An analysis platform for statistical and econometric models combining liquidity risk indicators and index with other economic and financial historical and real-time data sources to generate parameter estimates and make forecasts of future liquidity risk conditions, values of portfolios of assets, correlations, economic or financial data or predict asset returns, generate trade recommendations, and a securities screening module to identify buy and sell candidate securities based on their liquidity risk profile; and
5) Creation tradable financial instruments based on the value of the liquidity risk index, such that the derivative instruments (futures, options, options on futures) or Exchange Traded Fund (ETF) or some other financial instrument provide a method of hedging the risk quantified by the indicator.

A brief review of liquidity measures and liquidity risk are presented, as well as a description of common weighting methods for financial market indices.

Several types of liquidity measures have appeared in the financial literature. The most common types of measures are spread measures, which calculate the difference between quoted bid and ask prices in financial markets, volume measures, and time measures. Some variants include:

### Liquidity Measures

Trading Volume Per Time Interval (See, e.g., Lee, C. M. C., Mucklow, B. & Ready, M. J. (1993), ‘Spreads, depths and the impact of earnings information: An intraday analysis’, The Review of Financial Studies 6(2), 345-374.; Chordia, T., Subrahmanyam, A. & Anshuman, V. R. (2001), ‘Trading activity and expected stock returns’, Journal of Financial Economics 59, 3-32, which are hereby incorporated by reference herein in their entireties.)

$${Q}_{t} = {\sum }^{{N}_{t}} {q}_{i = 1} \text{?}$$

$$\text{?} \text{indicates text missing or illegible when filed}$$

where Q^{t} is the quantity of shares traded.

Volume Duration (See, e.g., Gourieroux, C., Jasiak, J. & Le Fol, G. (1999), ‘Intra-day market activity’, Journal of Financial Markets 2, 193-226, which is hereby incorporated by reference herein in its entirety):

$${DurQ}_{t}^{{Q}^{⋆}} - inf ( DurQ : {\sum }_{i = 1} \text{?} {q}_{i} \geq {\sum }_{i = 1} \text{?} {q}_{i} + {Q}^{⋆} )$$

$$\text{?} \text{indicates text missing or illegible when filed}$$

where DurQₜ^{Q*} is the time it takes to trade a certain number of shares Q* and Nt is the number of trades.

Turnover (See, e.g., Chordia, T. & Swaminathan, B. (2000), ‘Trading volume and cross-autocorrelations in stock returns’, The Journal of Finance 55(2), 913-935; Hasbrouck, J. & Seppi, D. J. (2001), ‘Common factors in prices, order flows and liquidity’, Journal of Financial Economics 59, 383-411, which are hereby incorporated by reference herein in their entireties):

$${V}_{t} = {\sum }_{i = 1}^{{N}_{t}} {p}_{i} q \vert$$

Quantity Depth (See, e.g., Huberman, G. & Halka, D. (2001), ‘Systematic liquidity’, The Journal of Financial Research 24(2), 161-178, which is hereby incorporated by reference herein in its entirety):

$${D}_{t} = {qt}^{A} + {qt}^{B}$$

where qₜ^{A} and qₜ^{R} refer to the best bid and the best ask volume in the order book.

Log Depth (See, e.g., Butler, A. W., Grullon, G. & Weston, J. P. (2002), Stock market liquidity and the cost of raising capital. Working Paper, which is hereby incorporated by reference herein in its entirety):

$$D {log}_{t} = ln ( {q}_{t}^{A} ) + ln ( {q}_{t}^{B} ) = ln ( {q}_{t}^{A} ⋆ {q}_{t}^{B} )$$

Dollar Depth (See, e.g., Brockman, P. & Chung, D. Y. (2000), ‘An empirical investigation of trading on asymmetric information and heterogeneous prior beliefs’, Journal of Empirical Finance 7, 417-454, which is hereby incorporated by reference herein in its entirety):

$$D {\$}_{t} = \frac{{q}_{t}^{A} ⋆ {p}_{t}^{A} + {q}_{t}^{B} ⋆ {p}_{t}^{B}}{2}$$

Number of Trades (See, e.g., Bacidore, J. M. (1997), ‘The impact of decimalization on market quality: An empirical investigation of the Toronto stock exchange’, Journal of Financial Intermediation 6(2), 92-120, which is hereby incorporated by reference herein in its entirety):

Nₜ

Waiting Time Between Trades (See, e.g., Gourieroux, C., Jasiak, J. & Le Fol, G. (1999), ‘Intra-day market activity’, Journal of Financial Markets 2, 193-226., which is hereby incorporated by reference herein in its entirety):

$$WT \text{?} = \frac{1}{N - 1} {\sum }_{i = 2}^{N} {tr}_{i} - {tr}_{i - 1}$$

$$\text{?} \text{indicates text missing or illegible when filed}$$

Number of Orders Per Time Unit (See, e.g., Walsh, D. M. (1998), ‘Evidence of price change volatility induced by the number and proportion of orders of a given size’, Australian Journal of Management 23(1), 39-55, which is hereby incorporated by reference herein in its entirety):

NOₜ

Absolute spread or dollar spread (See, e.g., Chordia, T., Roll, R. & Subrahmanyam, A. (2001), ‘Market liquidity and trading activity’, The Journal of Finance 56(2), 501-530, which is hereby incorporated by reference herein in its entirety):

$${Sabs}_{t} = {P}_{t}^{A} - {P}_{t}^{B}$$

Log Absolute Spread (See, e.g., Hamao, Y. & Hasbrouck, J. (1995), ‘Securities trading in the absence of dealers: Trades and quotes on the Tokyo Stock Exchange’, The Review of Financial Studies 8(3), 849-878, which is hereby incorporated by reference herein in its entirety):

$$Log {Sabs}_{t} = ln ( {Sabs}_{t} ) = ln ( {p}_{t}^{A} - {p}_{t}^{B} )$$

Relative Spread with Mid-Price (See, e.g., Levin, E. J. & Wright, R. E. (1999), ‘Explaining the intra-day variation in the bid-ask spread in competitive dealership markets—A research note’, Journal of Financial Markets 2, 179-191, which is hereby incorporated by reference herein in its entirety):

$${SrelM}_{t}^{M} = \frac{\text{?}}{{p}_{t}^{M}} = \frac{2 ( {p}_{t}^{A} - {p}_{t}^{B} )}{{p}_{t}^{A} + {p}_{t}^{B}}$$

$$where$$

$${p}_{t}^{M} = \frac{{p}_{t}^{A} + {p}_{t}^{B}}{2}$$

$$\text{?} \text{indicates text missing or illegible when filed}$$

Relative Spread with Last Trade (See, e.g., Fleming, M. J. & Remolona, E. M. (1999), ‘Price formation and liquidity in the U.S. Treasury market: The response to public

$$Srelp \text{?} = \frac{{p}_{t}^{A} - {p}_{t}^{B}}{{p}_{t}}$$

$$\text{?} \text{indicates text missing or illegible when filed}$$

information’, The Journal of Finance 54(5), 1901-1915., which is hereby incorporated by reference herein in its entirety):

Relative Spread of Log Prices (See, e.g., Hasbrouck, J. & Seppi, D. J. (2001), ‘Common factors in prices, order flows and liquidity’, Journal of Financial Economics 59, 383-411, which is hereby incorporated by reference herein in its entirety):

$$Srel {log}_{t} = ln ( {p}_{t}^{A} ) - ln ( {p}_{t}^{B} ) = ln ( \frac{{p}_{t}^{A}}{{p}_{t}^{B}} )$$

Log Relative Spread of Log Prices (See, e.g., Dacorogna, M. M., Gen9ay, R., Muller, U., Olsen, R. B. & Pictet, O. V. (2001), An Introduction to High-Frequency Finance, Academic Press, San Diego, which is hereby incorporated by reference herein in its entirety):

$$Log Srel {log}_{t} = ln ( Srel {log}_{t} ) = ln ( ln ( \frac{{p}_{t}^{A}}{{p}_{t}^{B}} ) )$$

Effective Spread (See, e.g., Christie, W. G. & Schultz, P. H. (1998), ‘Dealer markets under stress: The performance of NASDAQ® market makers during the Nov. 15, 1991, market break’, Journal of Financial Services Research 13(3), 205-229, which is hereby incorporated by reference herein in its entirety):

$${Seff}_{t} = \vert {p}_{t} - {p}_{t}^{M} \vert$$

Relative Effective Spread with Last Trade (See, e.g., Chordia, T., Roll, R. & Subrahmanyam, A. (2000), ‘Commonality in liquidity’, Journal of Financial Economics 56, 3-28, which is hereby incorporated by reference herein in its entirety):

$${Seffrelp}_{t} = \frac{\vert {p}_{t} - {p}_{t}^{M} \vert}{{p}_{t}}$$

Relative Effective Spread with Mid-Price (See, e.g., Grammig, J., Schiereck, D. & Theissen, E. (2001), ‘Knowing me, knowing you: Trader anonymity and informed trading in parallel markets’, Journal of Financial Markets 4, 385-412, which is hereby incorporated by reference herein in its entirety):

$${SeffrelM}_{t} = \frac{\vert {p}_{t} - {p}_{t}^{M} \vert}{{p}_{t}^{M}}$$

Quote Slope (See, e.g., Hasbrouck, J. & Seppi, D. J. (2001), ‘Common factors in prices, order flows and liquidity’, Journal of Financial Economics 59, 383-411, which is hereby incorporated by reference herein in its entirety):

$$Q {S}_{t} = \frac{{Sabs}_{t}}{D {log}_{t}} = \frac{{p}_{t}^{A} - {p}_{t}^{B}}{ln ( {q}_{t}^{A} ) + ln ( {q}_{t}^{B} )}$$

Log Quote Slope (See, e.g., Hasbrouck, J. & Seppi, D. J. (2001), ‘Common factors in prices, order flows and liquidity’, Journal of Financial Economics 59, 383-411, which is hereby incorporated by reference herein in its entirety):

$$Log {QS}_{t} = \frac{Srel {log}_{t}}{D {log}_{t}} = \frac{ln ( \frac{{p}_{t}^{A}}{{p}_{t}^{B}} )}{ln ( {q}_{t}^{A} ⋆ {q}_{t}^{B} )}$$

Adjusted Log Quote Slope (See, e.g., Chordia, T., Roll, R. & Subrahmanyam, A. (2000), ‘Commonality in liquidity’, Journal of Financial Economics 56, 3-28, which is hereby incorporated by reference herein in its entirety):

$$Log {QSadj}_{t} = \frac{ln ( \frac{{p}_{t}^{A}}{{p}_{t}^{B}} )}{ln ( {q}_{t}^{A} ⋆ {q}_{t}^{B} )} + \frac{\vert ln ( \frac{{q}_{t}^{B}}{{q}_{t}^{A}} ) \vert}{ln ( {q}_{t}^{A} ⋆ {q}_{t}^{B} )} ⋆ ln ( \frac{{p}_{t}^{A}}{{p}_{t}^{B}} )$$

Composite Liquidity (See, e.g., Chordia, T., Roll, R. & Subrahmanyam, A. (2000), ‘Commonality in liquidity’, Journal of Financial Economics 56, 3-28, which is hereby incorporated by reference herein in its entirety):

$${CL}_{t} = \frac{{SrelM}_{t}}{D {\$}_{t}}$$

Liquidity Ratio (See, e.g., Elyasiani, E., Hauser, S. & Lauterbach, B. (2000), ‘Market response to liquidity improvements: Evidence from exchange listings’, The Financial Review 41, 1-14, which is hereby incorporated by reference herein in its entirety):

$${LR}_{t} = \frac{{V}_{t}}{\vert {r}_{t} \vert}$$

Flow Ratio (See, e.g., Ranaldo, A. (2001), ‘Intraday market liquidity on the Swiss stock exchange’, Financial Markets and Portfolio Management 15(3), 309-327., which is hereby incorporated by reference herein in its entirety):

$${FR}_{t} = \frac{{V}_{t}}{{WT}_{t}}$$

Order Ratio (See, e.g., Ranaldo, A. (2001), ‘Intraday market liquidity on the Swiss stock exchange’, Financial Markets and Portfolio Management 15(3), 309-327., which is hereby incorporated by reference herein in its entirety):

$$O {R}_{t} = \frac{\vert {q}_{t}^{B} \to {q}_{t}^{A} \vert}{{V}_{t}}$$

Market Impact (See, e.g., Irvine, P., Benston, G. & Kandel, E. (2000), Liquidity beyond the inside spread: Measuring and using information in the limit order book, Working Paper, which is hereby incorporated by reference herein in its entirety):

$${MI}^{{V}^{*}} \text{?} = {p}_{t}^{A , {V}^{⋆}} - {p}^{B , {V}^{*}} \text{?}$$

$$\text{?} \text{indicates text missing or illegible when filed}$$

### Simple vs. Composite Liquidity Risk Index

Note that any single liquidity measure, or a combination of several liquidity measures, could be converted into a market-wide liquidity risk index if it were calculated in real-time and then indexed using a weighting methodology that mirrors any well-known financial market index, such as the S&P500®, or a portfolio-specific index if real-time price, quote and transaction data were available for all securities holdings in the portfolio. A composite measure could be created which combines any number of liquidity measures by applying weights to the various measures, each weight having a possible value between −1 and 1, inclusively, such that the weights for the various measures for each stock (each underlying index component) collectively sum to a fixed number, whereby the weights are assigned arbitrarily or obtained through some optimization method or a signal extraction method such as a rolling or recursive Principal Components Analysis, which must performed in a rolling or recursive fashion in order to eliminate the look-ahead bias inherent in standard Principal Components Analysis. A second weighting must then be applied to aggregate all the individual index components into a liquidity risk index which is calculated in real-time and weighted identically to the well-known index (e.g., S&P500® weighting). Therefore, a double weighting procedure is applied to the liquidity measures in order to convert the liquidity measures into a liquidity risk index, whereby such calculation receives real-time price, quote, and transaction data such that the index can be calculated in real-time.

### Index Weightings

Well-known financial market indices are weighted in a variety of ways. For example, the Dow Jones Industrial Average® is arithmetic average whereby the divisor is an arbitrary number. The S&P500® and the NASDAQ® Composite are weighted by market capitalization. The NASDAQ-100® Index is a modified market capitalization weighted index. The value of the Index equals the aggregate value of the Index share weights, also known as the Index Shares, of each of the Index Securities multiplied by each security's Last Sale Price, and divided by the divisor of the Index. The divisor serves the purpose of scaling such aggregate value to a lower order of magnitude which is more desirable for Index reporting purposes. The RUSSELL INDEXES® are weighted by market capitalization and a rule-based methodology whereby stocks are ranked from largest to smallest market capitalization at each year on May 31. The top 3,000 stocks become the Russell 3000 Index®, the largest 1,000 stocks become the Russell 1000 Index®, the next 2,000 stocks become the Russell 2000 Index®, and the smallest 1,000 in the Russell 2000 Index® plus the next smallest 1,000 comprise the Russell Microcap Index®.

The Barclays Capital Aggregate Bond Index® is a market-capitalization weighted index of corporate bonds, meaning the securities in the index are weighted according to the market size of each bond type. The S&P®/BGCANTOR® U.S. Treasury Bond Index is a broad, comprehensive, market-value weighted index that seeks to measure the performance of the U.S. Treasury Bond market. The US Dollar Index (USDX) is an index (or measure) of the value of the United States dollar relative to a basket of foreign currencies. It is a weighted geometric mean of the dollar's value compared only with:
Euro (EUR), 57.6% weight Japanese yen (JPY) 13.6% weight Pound sterling (GBP), 11.9% weight Canadian dollar (CAD), 9.1% weight
Swedish krona (SEK), 4.2% weight and Swiss franc (CHF) 3.6% weight

Any of these index weighting methodologies may be applied to liquidity measures for each of the underlying securities in order to create a liquidity risk index mirroring the well-known index, or some other weighting may be applied to mirror another index, or some arbitrary weighting may be applied to create a novel index. Similarly the methodology could be applied to measure the particular liquidity risk in any individual portfolio of assets held by an investor, wherein portfolio weights are applied.

Thus, the method described above allows for the calculation of either a market-wide Liquidity Risk Index or a customized portfolio-specific Liquidity Risk Index in real-time in exemplary embodiments of the present disclosure.

### B. Exemplary Network Environment

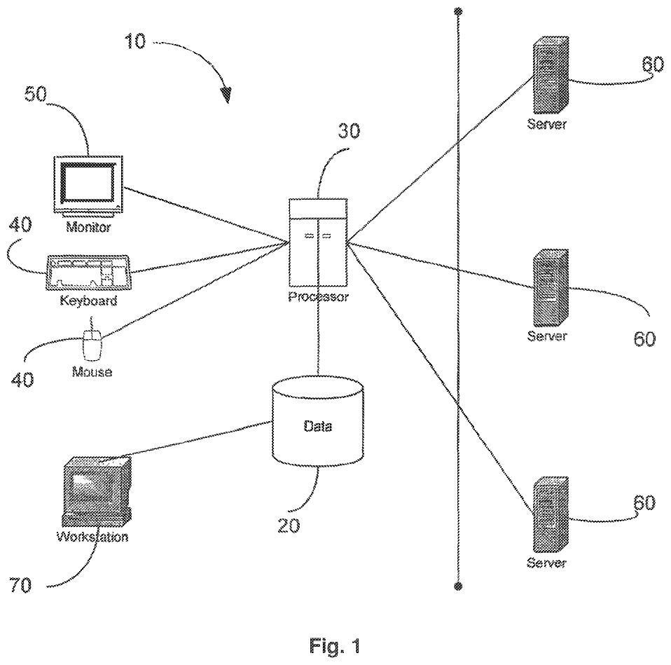

FIG. 1 illustrates an example environment in which exemplary embodiments of the present disclosure can be implemented. Relevant price, quote, volume data and other data can, for example, be stored on a relational database 20 (as are well known and provided by, for example, IBM®, Microsoft® Corporation, Oracle® and the like) associated with a computer system 10 provided with and running various computational hardware and software applications necessary to generate one or more indicators. Computer system 10 can include, for example, a microprocessor 30, which is understood to include various multiple core processors, various distributed processors, etc., memory (not shown), a storage medium (not shown), input devices (e.g., keyboard, mouse, microphone, etc.) 40, and one or more monitors 50. System 10 can, for example, be operated using a conventional operating system, and can include, for example, a graphical user interface for navigating and controlling various computational aspects of the present disclosure. System 10 can, for example, also be linked to one or more external data source servers 60 that feed system 10 with some or all of the necessary external data for computing the various indicators. Alternatively, as shown in FIG. 1, a stand-alone workstation 70, including a processor, memory, input devices and storage medium may be used to access database 20, or for example, a combination of database 20 and various external data source servers (not shown) akin to external data source servers 60.

Any suitable hardware and/or software can be used to perform the mechanisms described herein. For example, a general purpose device such as a computer or a special purpose device such as a client, a server, etc. can be used to execute software for performing the mechanisms described herein. Any of these general or special purpose devices can include any suitable components such as a hardware processor (which can be a microprocessor, digital signal processor, a controller, etc.), memory, communication interfaces, display controllers, input devices, etc. This hardware and/or software can be implemented as part of other equipment or can be implemented as stand-alone equipment (which can be coupled to other equipment).

In some embodiments, any suitable computer readable media can be used for storing instructions for performing the processes described herein. For example, in some embodiments, computer readable media can be transitory or non-transitory. For example, non-transitory computer readable media can include media such as magnetic media (such as hard disks, floppy disks, etc.), optical media (such as compact discs, digital video discs, Blu-ray discs, etc.), semiconductor media (such as flash memory, electrically programmable read only memory (EPROM), electrically erasable programmable read only memory (EEPROM), etc.), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

### C. Exemplary Operation

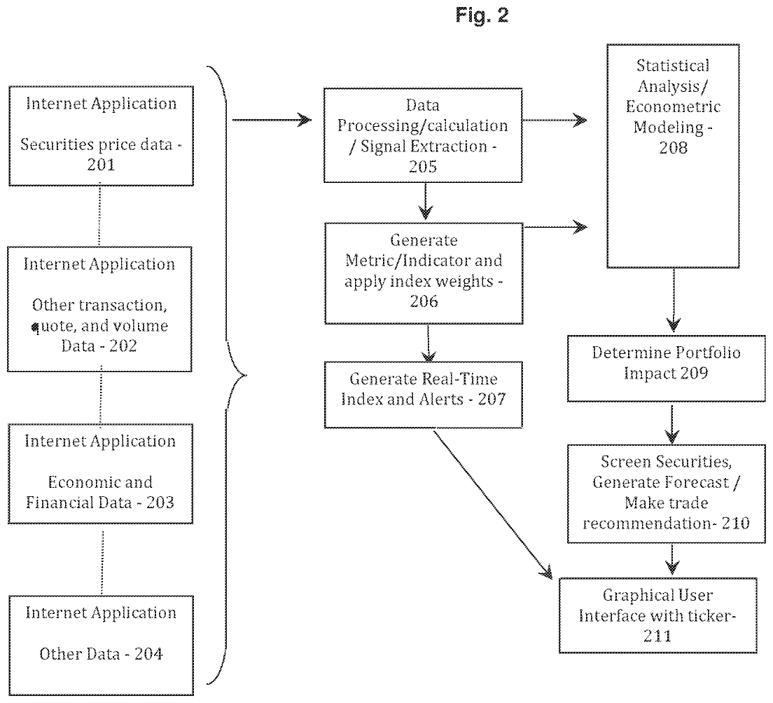

FIG. 2 illustrates a basic process according to exemplary embodiments of the present disclosure. In operation, a forecast, portfolio analysis or trade recommendation generated at 210 can analyze liquidity risk and forecast financial quantities in the following general manner. Forecast 210 can generate and/or receive parameters generated by portfolio impact 209 and statistical analysis/econometric modeling 208, which receives automatically, via a network, or manually entered by a user, a set of indicators at 206 which have been processed at 205 and/or receive directly other data which has been processed solely at 206. Data received at 206 can comprise data received from various Internet applications such as, but not limited to, securities prices and other asset data 201, other transaction, quote indication and volume data 202, economic and financial data 203, and/or other data 204. In the processing node at 205, the data are cleaned, transformed and normalized; primary liquidity measures are calculated and prepared for analysis. If a composite indicator is to be generated from multiple measures of liquidity, a signal is extracted from multiple liquidity measures at node 206. A real-time index and alerts is generated at 207 to notify a user if the level of liquidity risk has surpassed a pre-defined threshold, whereby such alert can be text (email, tweet, or SMS message), visual (a lightbulb changing colors), graphical, auditory (chimes, bells, etc.), or a scrolling ticker of values, levels, or changes (numerical or percent).

As noted above, where multiple liquidity measures are chosen to construct a composite indicator, such measures can be combined into one composite indicator by assigning weights to each data source after the data are processed and transformed accordingly, whereby the weights can range in value between −1 and 1, and must collectively sum to a fixed number. In exemplary embodiments of the present disclosure the weights can be assigned either arbitrarily or by some means of optimization, such as, for example, by applying a signal extraction algorithm to find the common signal among the various data.

Signal extraction algorithm 206 can be, for example, a static, rolling, or recursive Principal Components Analysis which is an eigenvalue decomposition of a covariance or correlation matrix, or a matrix of pairwise correlations and covariances, or a method such as a Kalman Filter, or the Wiener-Kolmogorov (WK) signal extraction formulae, or some other method which modifies or incorporates elements of one or several well-known optimization or signal extraction techniques, such as the hybrid MPCA-KF signal extraction algorithm described in commonly-owned, commonly-assigned U.S. patent application Ser. No. 13/677,273, entitled “METHODS AND SYSTEMS TO CREATE SYNTHETIC VARIABLES, INDICATORS AND INDICES FROM MULTIPLE DATA AND METADATA SOURCES AND RISK MANAGEMENT CONTRACTS THEREON,” which was filed on even date herewith. It is understood that such signal extraction methods may need to be modified due to the unique properties of this type of data. In exemplary embodiments of the present disclosure it is also possible to employ various signal extraction techniques in order to construct various candidate indicators, composite indicators, or indices and then select the indicator or index which results in the lowest forecast error of estimated parameters, i.e., select the indicator or index which results in the best forecast.

In exemplary embodiments of the present disclosure an example system can offer as a choice several well-known optimization or signal extraction algorithms, the hybrid MPCA-KF algorithm described in above-mentioned U.S. patent application Ser. No. 13/677,273, entitled “METHODS AND SYSTEMS TO CREATE SYNTHETIC VARIABLES, INDICATORS AND INDICES FROM MULTIPLE DATA AND METADATA SOURCES AND RISK MANAGEMENT CONTRACTS THEREON,” or some other hybrid or modified optimization or signal extraction method. All possible optimization or signal extraction methods can be applied concurrently in order to identify the method that results in the lowest forecast error or the highest predictive power. An example system can run several signal extraction algorithms at once to generate candidate indices or indicators. These candidate variables can then be tested concurrently in a statistical or econometric forecasting model. The example system can then automatically identify the candidate indicator that produces the lowest forecast error or the highest predictive power, and recommend that indicator as a suitable indicator to the user.

The resulting composite liquidity risk indicator generated at 206 can be a linear combination of the various liquidity measures, such as a weighted average, or some other linear combination, whereby the weights assigned to each data source can range in value from −1 to 1, inclusively, and collectively sum to a fixed number. At 206 the single liquidity measure or composite liquidity measure is applied to each underlying security index component in a well-known financial market index and then the index weights are applied to all securities such that an index is formed which has the same composition as the well-known index.

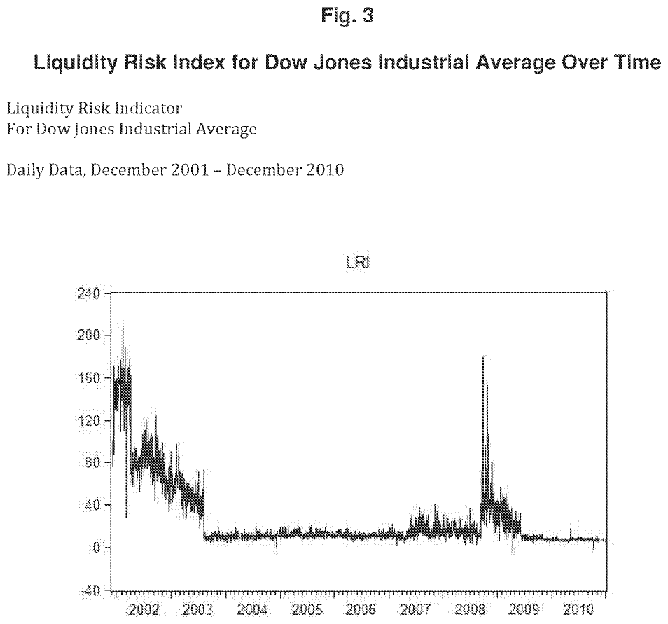

FIG. 3 depicts exemplary an exemplary Liquidity Risk Index for the Dow Jones Industrial Average® over time.

A graph can represent data such as, the liquidity risk index for the Dow Jones Industrial Average® trending over time, as shown in FIG. 3. With reference thereto, FIG. 3 depicts an exemplary graphical display of a liquidity risk index. It is understood that such graphical depiction may also include one or more of the following:
(i) calculating and displaying how the liquidity risk trends over time;
(ii) calculating and displaying how the liquidity risk varies by individual securities, groups of securities or assets in a portfolio,
(iii) calculating and displaying how the liquidity risk index concurrently trends over time and varies by groups of securities or assets in a portfolio, in order to determine if trends are similar or different among different actual or hypothetical groups of securities in a portfolio;
(iv) calculating and displaying an overall volume of liquidity risk in financial markets per unit of time;
(v) calculating and displaying how said liquidity risk trends over time and would vary by changing the composition of a portfolio;
(vi) calculating and displaying the liquidity risk of certain securities or assets, relative to other financial or economic risks;
(vii) calculating and displaying the liquidity risk of certain securities or assets relative to other subject matter in the same category.

It is also understood that exemplary graphical display may be accompanied by or include the capacity to generate real-time graphical, numerical, visual or textual alerts regarding current or expected liquidity risk in financial markets or of certain securities or assets in a portfolio, wherein said alerts can be in the form of a scrolling ticker displaying levels or changes (numerical or percent) of liquidity risk index, or generating an alert when the liquidity risk index surpasses some threshold, wherein said defined threshold level is 5% or some other quantity greater than the average daily liquidity risk, and, wherein the real-time alerts are based on user-configurable conditions or parameters including one or more of:
(i) abnormally positive liquidity risk levels;
(ii) abnormally negative liquidity risk levels;
(iii) changes in liquidity risk levels above or below a pre-selected threshold;

It is also understood that such a system utilizes a graphical user interface comprising a unique combination of (i) data calculation capabilities, (ii) statistical and econometric analysis and (iii) graphical reporting tools to measure and index liquidity risk in a portfolio, or financial markets generally, and recommending trades or asset substitutions in a portfolio to change the liquidity risk profile of the portfolio, (iv) a scrolling ticker.

It is also understood that such a system may display in a graphical user interface one or more visualizations of analytic measurements of liquidity risk.

Such a system may further comprise displaying one or more of: How liquidity risk:
(i) trends over time,
(ii) varies by groups of securities or assets in a portfolio or financial markets at large, and
(iii) concurrently trends over time and varies by groups of securities or assets in a portfolio or financial markets at large.

It is also understood that such a system may comprise displaying liquidity risk, in comparison to other benchmark indices or other risks, such as volatility, correlation, or sentiment, or historical returns on an index, asset class, or individual security. Additionally, such a system may comprise liquidity risk, in comparison to the consensus view of current or future economic conditions or asset prices.

Such a system may further comprise displaying how liquidity risk concerning any user-configurable collection of securities or assets trends over a user-configurable time period, geographical region, industry group, or style category.

It is understood that such a system may further comprise a graphical user interface that allows a user to configure parameters, such as a wizard which prompts the user to set parameters by which the system calculates, delivers, and displays liquidity risk metric for such a user-configurable measure. In addition, such a system may further read portfolio data such as holdings from an online source of account data, such as from an online brokerage account and generate recommendations. Alternatively, the system may accept manual inputs of portfolio holdings data, or accept such data by means of file upload from a format such as Excel or ascii.

To further concretize the above discussion, an example calculation of a liquidity risk index is next described.

### Example 6—Liquidity Risk Index and Method of Hedging Liquidity Risk

An index of liquidity risk for a certain asset class can be created, as well as an overall level of liquidity risk in financial markets. In the case of one asset class, the indicator can be calculated as follows, for example for an index of equities, such as the S&P500®.

Measure of liquidity risk is converted to an aggregate market-wide index measure which can be calculated in real-time. However, note that a composite measure could be created which combines any number of liquidity indicators by applying weights to the various measures, such weights ranging in value between −1 and 1, inclusively, and collectively summing to a fixed number, whereby the weights are assigned arbitrarily or obtained through some optimization method or a signal extraction method such as a rolling or recursive Principal Components Analysis, which must performed in a rolling or recursive fashion in order to eliminate the look-ahead bias inherent in standard Principal Components Analysis. A second weighting procedure using pre-defined index weighting methodology would convert the composite liquidity measures for each security to an aggregate market-wide liquidity risk index.

Let the difference between the lowest Ask price at time t, A, and the highest Bid price at time t, s for stock xₗ be called the spread, calculated as follows:

$${Spread}_{x} = {P}^{A} \text{?} - {P}^{B} \text{?}$$

$$\text{?} \text{indicates text missing or illegible when filed}$$

Let the ratio of the spread for stock [symbol] relative to the last transaction price, L executed for stock [symbol] measure the liquidity risk for stock

[symbol]

$${L}_{t}^{X} - \frac{( {P}_{t}^{A} - {P}_{t}^{B} )}{{P}_{t}^{L}}$$

It is noted that as an alternate to the last transaction price, a mid-price can be calculated whereby the midprice, M, is equal to the sum of the bid and ask divided by two, i.e.,

$${P}_{t}^{M} = \frac{( {P}_{t}^{A} - {P}_{t}^{B} )}{2}$$

In this case,

$${L}_{t}^{X} - \frac{( {P}_{t}^{A} - {P}_{t}^{B} )}{{P}_{t}^{M}}$$

$$or$$

$${L}_{t}^{X} = 2 ⋆ \frac{( {P}_{t}^{A} - {P}_{t}^{B} )}{( {P}_{t}^{A} + {P}_{t}^{B} )}$$

It is noted that as an alternate to the last transaction price or the mid-price, the volume-weighted average price (VWAP) at time t, vwAP can also be used. In this case we have:

$${L}_{t}^{X} - \frac{( {P}_{t}^{A} - {P}_{t}^{B} )}{{P}_{t}^{VWAP}}$$

Alternatively, the volume-weighted average bid and ask prices can be used as well,

$${L}_{t}^{X} = \frac{( {P}_{t}^{AVWAP} - {P}_{t}^{BVWAP} )}{{P}_{t}^{VWAP}}$$

In the case of daily data the closing bid, ask, and last sale price would be used.

$${L}_{t}^{X} - \frac{( {P}_{t}^{CA} - {P}_{t}^{CB} )}{{P}_{t}^{CL}}$$

Alternatively, any combination of liquidity measures maybe applied to form a composite liquidity measure which is then converted to an index by applying an index-weighting methodology.

It is noted that for any of these measures, the log could be taken, which would improve the distributional qualities, or an absolute value measure could also be used, or some other mathematical or statistical transformation could be applied.

It is noted that any of the liquidity measures can be adjusted by a multiplier M and/or a scalar S. It is understood that the multiplier M and scalar S may take on any value, including 1 and 0, respectively.

Note that normalizing the spread with price in the denominator (last transaction, mid-price, VWAP, closing price, etc.) facilitates comparability across stocks.

A Liquidity Risk Index can be calculated as a counterpart to any well-known financial market index. For example, a liquidity risk index for the S&P500® could be calculated as follows:

Let wₓᵢ represent the market capitalization weight of stock Xᵢ which is the i-th index component in the S&P500® index. That is, let

$${w}_{x i} = \frac{{P}_{xi} {S}_{xi}}{{{\sum }^{500}}_{i = 1} {P}_{xi} {S}_{xi}}$$

where
Pₓᵢ.=Price of stock Xᵢ, the i-th index component
Sₓᵢ=Float-adjusted shares outstanding of stock X, the i-th index component

Then an index of liquidity risk for the S&P500® can be calculated as follows:

$$L R {I}_{S \& P} = {{\sum }^{500}}_{i = 1} {w}_{x i} {{\sum }^{n}}_{j = 1} {w}_{j , xi} {L}_{j , xi} * M + S$$

Where wₓᵢ are index weights for each security xᵢ, w_{J,xi} are weights for any j of n liquidity measures L_{J,xi} for each security xi, whereby such weights for the liquidity measures can range between −1 and 1 inclusively and must collectively sum to a fixed number, M is a multiplier and S is a scalar. It is understood that the multiplier M and scalar S may take on any value, including 1 and 0, respectively. This equation illustrates the double-weighting procedure.

Since the S&P500® is calculated in real-time, the Liquidity Risk Index for the S&P500® can also be calculated in real-time, provided that price, quote, and transaction data are available in real-time.

A similar construction can be used for a Liquidity Risk Index for the Dow Jones Industrial Average® (DJIA®), which is a price-weighted index whereby the sum of the component stock prices for each stock X is divided by a Divisor, d, which adjusts the index for stock splits, spinoffs, and other structural changes. Thus, the DJIA® is calculated as:

$$D J I A = \frac{{{\sum }^{30}}_{i = 1} = {P}_{xi}}{d}$$

The current value of the divisor is d=0.132129493

In this case, the Liquidity Risk Index for the DJIA® is given by:

$${LRI}_{DOW} = \frac{{{\sum }^{30}}_{i = 1} = {L}_{xi}}{d}$$

Since the DJIA® is calculated in real-time, the Liquidity Risk Index for the DJIA® can also be calculated in real-time, provided that price, quote, and transaction data are available in real-time.

It is noted that a similar construction could be utilized to create a liquidity risk index LRI for US corporate bonds, such as a measure of liquidity risk corresponding to a bond index such as the NASO-Bloomberg® Active Investment Grade U.S. Corporate Bond Index, or for Chinese corporate bonds using the S&P®/CITIC Corporate Bond Index. The S&P®/CITIC Corporate Bond Index is one of five distinct fixed indices designed to track China's government corporate, inter-bank, and convertible bond markets. It includes all corporate bonds listed on either SSE or SZSE. All exchange-traded bonds with terms to maturity above one year, fixed coupon rate including zero coupon bonds that detach at maturity, par outstanding above 100 million RMB, and an investment grade credit rating are included in the index. Since the S&P®/CITIC index is calculated real-time, the Liquidity Risk Index for Chinese corporate bonds could also be calculated in real time.

Similarly, a liquidity risk index LRI can be calculated in the market for foreign exchange, where a liquidity risk measure is calculate from the bid-ask spread quoted for n currency pairs, and a liquidity risk measure can be calculated for each unique currency pairs, where for n currencies there exist n(n−1)/2 unique currency pairs, and in addition a composite liquidity risk index LRI can be calculated for a all currency pairs or a subset of currency pairs, such as for the DXY dollar index.

Similarly, a liquidity risk index can be created for emerging market equities, mirroring the components and weights, for example, of the MSCI index.

In the case an overall liquidity risk index for the economy or the financial markets, a composite indicator can be created by determining weights for the liquidity risk corresponding to each asset and a linear combination of these liquidity risk measures combine to create an overall measure of liquidity risk for an asset class or a group of assets in financial markets.

A liquidity risk index LRI can be calculated for any individual security, portfolio, collection of securities, asset class or collection assets.

Derivative instruments-futures, options, and options on futures—can be issued to track the value of each underlying liquidity metric, as well as the composite or aggregate LRI, allowing financial market participants to speculate on the value of the liquidity indicator for each security. Similarly, an Exchange Traded Fund or other financial instruments can be created to track the value of the index. As the price of each underlying contract on liquidity changes, the LRI would change value in real time as the prices of the underlying assets change. Derivative instruments—futures, options, and options on futures or other financial instruments—can be issued to track the value of the liquidity risk index, providing market participants with a method to hedge the liquidity risk for assets in a portfolio.

Sample code—Eviews program to calculate liquidity risk for DJIA®
Liquidity Risk Index for Dow Jones Industrial Average® (DJIA®), monthly data from December 2001-December 2010
and Granger Causality Tests to determine liquidity measure's predictive power for future returns on the DJIA®
See Excel data files: dow_ 01032012_ REVERSED FINAL.xis and GC test_pvals_01062012.xls
Since index components change occasionally, the securities are first designated as either constant (C), or Switch(S) series to reflect index component changes over time.
First, rename the series so that X goes from 1 to 30
series CLO_X1=CLO_C1
series BID X1=BID_C1
series ASK_X1=ASK_C1
series VOL_X1=VOL_C1
series CLO_X2=CLO_C2
series BID_X2=BID_C2
series ASK_X2=ASK_C2
series VOL_X2=VOL_C2
series CLO_X3=CLO_C3
series BID_X3=BID_C3
series ASK_X3=ASK_C3
series VOL_X3=VOL_C3
series CLO_X4=CLO_C4
series BID_X4=BID_C4
series ASK_X4=ASK_C4
series VOL_X4=VOL_C4
series CLO_X5=CLO_C5
series BID_X5=BID_C5
series ASK_X5=ASK_C5
series VOL_X5=VOL_C5
series CLO_X6=CLO_C6
series BID_X6=BID_C6
series ASK_X6=ASK_C6
series VOL_X6=VOL_C6
series CLO_X7=CLO_C7
series BID_X7=BID_C7
series ASK_X7=ASK_C7
series VOL_X7=VOL_C7
series CLO_X8=CLO_C8
series BID_X8=BID_C8
series ASK_X8=ASK_C8
series VOL_X8=VOL_C8
series CLO_X9=CLO_C9
series BID_X9=BID_C9
series ASK_X9=ASK_C9
series VOL_X9=VOL_C9
series CLO_X10=CLO_C10
series BID_X10=BID_C10
series ASK_X10=ASK_C10
series VOL_X10=VOL_C10
series CLO_X11=CLO_C11
series BID_X11=BID_C11
series ASK_X11=ASK_C11
series VOL_X11=VOL_C11
series CLO_X12=CLO_C12
series BID_X12=BID_C12
series ASK_X12=ASK_C12
series VOL_X12=VOL_C12
series CLO_X13=CLO_C13
series BID_X13=BID_C13
series ASK_X13=ASK_C13
series VOL_X13=VOL_C13
series CLO_X14=CLO_C14
series BID X14=BID_C14
series ASK X14=ASK_C14
series VOL X14=VOL_C14
series CLO_X15=CLO_C15
series BID_X15=BID_C15
series ASK_X15=ASK_C15
series VOL_X15=VOL_C15
series CLO_X16=CLO_C16
series BID_X16=BID_C16
series ASK_X16=ASK_C16
series VOL_X16=VOL_C16
series CLO_X17=CLO_C17
series BID_X17=BID_ C17
series ASK_X17=ASK_C17
series VOL_X17=VOL_C17
series CLO_X18=CLO_C18
series BID_X18=BID_C18
series ASK_X18=ASK_C18
series VOL_X18=VOL_C18
series CLO_X19=CLO_C19
series BID_X19=BID_C19
series ASK_X19=ASK_C19
series VOL_X19=VOL_C19
series CLO_X20=CLO_C20
series BID_X20=BID_C20
series ASK_X20=ASK_C20
series VOL_X20=VOL_C20
series CLO_X21=CLO_C21
series BID_X21=BID_C21
series ASK_X21=ASK_C21
series VOL_X21=VOL_C21
series CLO_X22=CLO_C22
series BID_X22=BID_C22
series ASK_X22=ASK_C22
series VOL_X22=VOL_C22
series CLO_X23=CLO_S1
series BID_X23=BID_S1
series ASK_X23=ASK_S1
series VOL_X23=VOL_S1
series CLO_X24=CLO_S2
series BID_X24=BID_S2
series ASK_X24=ASK_S2
series VOL_X24=VOL_S2
series CLO_X25=CLO_S3
series BID_X25=BID_S3
series ASK_X25=ASK_S3
series VOL_X25=VOL_S3
series CLO_X26=CLO_S4
series BID_X26=BID_S4
series ASK_X26=ASK_S4
series VOL_X26=VOL_S4
series CLO_X27=CLO_S5
series BID_X27=BID_S5
series ASK_X27=ASK_S5
series VOL_X27=VOL_S5
series CLO_X28=CLO_S6
series BID_X28=BID_S6
series ASK_X28=ASK_S6
series VOL_X28=VOL_S6
series CLO_X29=CLO_S7
series BID_X29=BID_S7
series ASK_X29=ASK_S7
series VOL_X29=VOL_S7
series CLO_X30=CLO_S8
series BID_X30=BID_S8
series ASK_X30=ASK_S8
series VOL_X30=VOL_S8

generate series and do calculation

$$series LIQ\_X 1 = ( ( ASK\_X 1 - BID\_X 1 ) / CLO\_X 1 ) ⋆ 100$$

$$series LIQ\_X 2 = ( ( ASK\_X 2 - BID\_X 2 ) / CLO\_X 2 ) ⋆ 100$$

$$series LIQ\_X 3 = ( ( ASK\_X 3 - BID\_X 3 ) / CLO\_X 3 ) ⋆ 100$$

$$series LIQ\_X 4 = ( ( ASK\_X 4 - BID\_X 4 ) / CLO\_X 4 ) ⋆ 100$$

$$series LIQ\_X 5 = ( ( ASK\_X 5 - BID\_X 5 ) / CLO\_X 5 ) ⋆ 100$$

$$series LIQ\_X 6 = ( ( ASK\_X 6 - BID\_X 6 ) / CLO\_X 6 ) ⋆ 100$$

$$series LIQ\_X 7 = ( ( ASK\_X 7 - BID\_X 7 ) / CLO\_X 7 ) ⋆ 100$$

$$series LIQ\_X 8 = ( ( ASK\_X 8 - BID\_X 8 ) / CLO\_X 8 ) ⋆ 100$$

$$series LIQ\_X 9 = ( ( ASK\_X 9 - BID\_X 9 ) / CLO\_X 9 ) ⋆ 100$$

$$series LIQ\_X 10 = ( ( ASK\_X 10 - BID\_X 10 ) / CLO\_X 10 ) ⋆ 100$$

$$series LIQ\_X 11 = ( ( ASK\_X 11 - BID\_X 11 ) / CLO\_X 11 ) ⋆ 100$$

$$series LIQ\_X 12 = ( ( ASK\_X 12 - BID\_X 12 ) / CLO\_X12 ) ⋆ 100$$

$$series LIQ\_X 13 = ( ( ASK\_X 13 - BID\_X 13 ) / CLO\_X 13 ) ⋆ 100$$

$$series LIQ\_X 14 = ( ( ASK\_X 14 - BID\_X 14 ) / CLO\_X 14 ) ⋆ 100$$

$$series LIQ\_X 15 = ( ( ASK\_X 15 - BID\_X 15 ) / CLO\_X 15 ) ⋆ 100$$

$$series LIQ\_X 16 = ( ( ASK\_X 16 - BID\_X 16 ) / CLO\_X 16 ) ⋆ 100$$

$$series LIQ\_X 17 = ( ( ASK\_X 17 - BID\_X 17 ) / CLO\_X 17 ) ⋆ 100$$

$$series LIQ\_X 18 = ( ( ASK\_X 18 - BID\_X 18 ) / CLO\_X 18 ) ⋆ 100$$

$$series LIQ\_X 19 = ( ( ASK\_X 19 - BID\_X 19 ) / CLO\_X 19 ) ⋆ 100$$

$$series LIQ\_X 20 = ( ( ASK\_X 20 - BID\_X 20 ) / CLO\_X 20 ) ⋆ 100$$

$$series LIQ\_X 21 = ( ( ASK\_X 21 - BID\_X 21 ) / CLO\_X 21 ) ⋆ 100$$

$$series LIQ\_X 22 = ( ( ASK\_X 22 - BID\_X 22 ) / CLO\_X 22 ) ⋆ 100$$

$$series LIQ\_X 23 = ( ( ASK\_X 23 - BID\_X 23 ) / CLO\_X 23 ) ⋆ 100$$

$$series LIQ\_X 24 = ( ( ASK\_X 24 - BID\_X 24 ) / CLO\_X 24 ) ⋆ 100$$

$$series LIQ\_X 25 = ( ( ASK\_X 25 - BID\_X 25 ) / CLO\_X 25 ) ⋆ 100$$

$$series LIQ\_X 26 = ( ( ASK\_X 26 - BID\_X 26 ) / CLO\_X 26 ) ⋆ 100$$

$$series LIQ\_X 27 = ( ( ASK\_X 27 - BID\_X 27 ) / CLO\_X 27 ) ⋆ 100$$

$$series LIQ\_X 28 = ( ( ASK\_X 28 - BID\_X 28 ) / CLO\_X 28 ) ⋆ 100$$

$$series LIQ\_X 29 = ( ( ASK\_X 29 - BID\_X 29 ) / CLO\_X 29 ) ⋆ 100$$

$$series LIQ\_X 30 = ( ( ASK\_X 30 - BID\_X 30 ) / CLO\_X 30 ) ⋆ 100$$

calculate Liquidity Risk Index AND divide by Dow divisor
series LRI_L=(LIQ_X1+LIQ_X2+LIQ_X3+LIQ_X4+LIQ_X5+LIQ_X6+LIQ_X7+LIQ_X8+LIQ_X9+LIQ_X10+LIQ_X11+LIQ_X12+LIQ_X13+LIQ_X14+LIQ_X15+LIQ_X16+LIQ_X17+LIQ_X18+LIQ_X19+LIQ_X20+LIQ_X21+LIQ_X22+LIQ_X23+LIQ_X24+LIQ_X25+LIQ_X26+LIQ_X27+LIQ_X28+LIQ_X29+LIQ_X30)/DIV
DIV is time series of Dow Jones Industrial Average® Divisor
calculate liquidity risk index percent change series LRI_C=@pc(LRI_L)
form group of DJIA percent change and LRI percent change group dowliq djia_c Iri_c
make table to hold lag pvals table(48,2) gc_pvals
   gc_pvals(1,1)=“DJIA_P” gc_pvals(1,2)=“LRI_P”
!row=2
do Granger Causality to determine whether changes in Liquidity risk Granger causes DJIA returns
specify lag variable for !lag=1 to 47
do Granger test
freeze(gc_!lag) dowliq.cause(!lag)
identify results to extract
scalar LRI_P=@val(gc_!lag(8,4)) scalar DJIA_P=@val(gc_!lag(9,4))
extract to table

$$gc\_pvals ( ! row , 1 ) = DJIA\_P gc\_pvals ( ! row , 2 ) = LRI\_P$$

tell it to fill each row

$$! row = ! row + 1 next$$

| | Dec. 1 2001- | Apr. 8 2004- | Nov. 21 2005. | Feb. 19 2008- | Sep. 22 2008- | Jun. 8 2009- | |
|---|---|---|---|---|---|---|---|
| Company | Apr. 1 2004 | Nov. 20 2005 | Feb. 18 2008 | Sep. 21 2008 | os.01.09 | present | |
| AT&T, AIG, Kraft Foods | T | AIG | AIG | AIG | KFT | KFT | S1 |
| Eastman Kodak, Pfizer Inc. | EK IP | PFE | PFE | PFE | PFE | PFE | S2 S3 |
| International Paper Company, | | VZ | VZ | VZ | VZ | VZ | |
| Verizon Communications Inc. | SBC MO HON | | | | | | S4 S5 |
| SBC Communications, AT&T | | SBC MO HON | T MO HON | T BAC | T BAC | T BAC | S6 |
| Altria Group, Bank of America | C GM | | | CVX | CVX | CVX | |
| Honeywell International Inc., | | C GM | C GM | | | | S7 SB |
| Chevron Corporation Citigroup, | | | | C GM | C GM | TRV | |
| Cisco Systems | | | | | | CSCO | |
| General Motors, Travelers Cos. | | | | | | | |
| 3M Co. | MMM | MMM | MMM | MMM | MMM | MMM | C1 |
| Alcoa Inc. | AA | AA | AA | AA | AA | AA | C2 |
| American Express Co. | AXP | AXP | AXP | AXP | AXP | AXP | C3 |
| Boeing Co. | BA | BA | BA | BA | BA | BA | C4 |
| Caterpillar Inc. | CAT | CAT | CAT | CAT | CAT | CAT | C5 |
| Coca-Cola Co. | KO | KO | KO | KO | KO | KO | C6 |
| E.I. DuPont de Nemours | DD | DD | DD | DD | DD | DD | C7 |
| & Co. | | | | | | | |
| Exxon Mobil Corp. | XOM | XOM | XOM | XOM | XOM | XOM | CB |
| General Electric Co. | GE | GE | GE | GE | GE | GE | C9 |
| Hewlett-Packard Co. | HPQ | HPQ | HPQ | HPQ | HPQ | HPQ | C10 |
| Home Depot Inc. | HD | HD | HD | HD | HD | HD | C11 |
| Intel Corp. | INTC | INTC | INTC | INTC | INTC | INTC | C12 |
| International Business | IBM | IBM | IBM | IBM | IBM | IBM | C13 |
| Machines Corporation | | | | | | | |
| Johnson & Johnson | JNJ | JNJ | JNJ | JNJ | JNJ | JNJ | C14 |
| JPMorgan Chase & Co. | JPM | JPM | JPM | JPM | JPM | JPM | C15 |
| McDonald's Corp. | MCD | MCD | MCD | MCD | MCD | MCD | C16 |
| Merck & Co. Inc. | MRK | MRK | MRK | MRK | MRK | MRK | C17 |
| Microsoft Corp. | MSFT | MSFT | MSFT | MSFT | MSFT | MSFT | C18 |
| Procter & Gamble Co. | PG | PG | PG | PG | PG | PG | C19 |
| United Technologies Corp. | UTX | UTX | UTX | UTX | UTX | UTX | C20 |
| Wal-Mart Stores Inc. | WMT | WMT | WMT | WMT | WMT | WMT | C21 |
| Walt Disney Co. | DIS | DIS | DIS | DIS | DIS | DIS | C22 |

What is claimed is:

1. A computer-implemented method for tracking aggregated quantified liquidity risk across a plurality of assets, the method comprising:
accessing data from a plurality of data sources including transactional data, wherein the transactional data comprises respective pricing information and reference data for respective assets in a plurality of assets;
measuring, with a statistical process, a respective change in liquidity of each of the respective assets based on at least one of an estimated projected trade volume capacity of the respective asset, an estimated volatility of the respective asset, an estimated time to liquidate the respective asset, and an estimated cost to liquidate the respective asset to obtain respective measurements of respective changes in liquidity of the respective assets;
aggregating, at a portfolio level, the respective measurements of respective changes in liquidity of the respective assets to obtain an aggregated quantified indicator of liquidity risk for the portfolio,
wherein the aggregated quantified indicator of liquidity risk has a value in a bounded range from 0 to 100, and wherein a higher value in the bounded range of the aggregated quantified indicator of liquidity risk indicates a higher projected level of liquidity of the portfolio as compared with a lower value in the bounded range; and
generating a display for a graphical user interface or a file of the aggregated quantified indicator of liquidity risk.

2. The method of claim 1, wherein when the aggregated quantified indicator of liquidity risk has a value of 0 the aggregated quantified indicator of liquidity risk is associated with a weighted average liquidity cost estimate of 10%, and wherein when the aggregated quantified indicator of liquidity risk has a value of 100 the aggregated quantified indicator of liquidity risk is associated with a liquidity cost estimate of 0%.

3. The method of claim 1, wherein the respective measurements of respective changes in liquidity of the respective assets and the aggregated quantified indicator of liquidity risk for the portfolio comprise a plurality of quantified liquidity risk indicators and wherein at least one of the respective measurements of respective changes in liquidity of the respective assets and the aggregated quantified indicator of liquidity risk for the portfolio comprise a ratio.

4. The method of claim 3, wherein the ratio comprises a respective estimated projected volatility for the respective asset as at least one of a numerator and a denominator and a respective estimated projected trade volume for the respective asset as at least one of a denominator and a numerator.

5. The method of claim 4, further comprising ranking the respective ratios from the plurality of quantified liquidity risk indicators to obtain ranked ratios.

6. The method of claim 5, wherein the ranking comprises ranking the respective ratios from at least one of a highest rank to a lowest rank and a lowest rank to a highest rank and wherein a rank is associated with a level of liquidity.

7. The method of claim 6, further comprising generating a set of respective liquidity risk scores for the respective assets based on the ranking.

8. The method of claim 7, wherein the ranking further comprises ranking the set of respective liquidity risk scores for the respective assets against the respective liquidity risk scores for at least one of the plurality of assets, a group of assets, a portfolio of assets, at least one asset in the same asset class, at least one asset within the same sector, at least one asset of the same issuer, and at least one asset with similar characteristics.

9. The method of claim 3, wherein the ratio comprises at least one of (i) a ratio of a computed absolute return to a computed dollar transaction volume for a respective asset from the plurality of assets, (ii) a ratio of a projected absolute return to a projected dollar transaction volume for a respective asset from the plurality of assets, and (iii) a ratio of projected price volatility to projected trading volume for a respective asset from the plurality of assets.

10. The method of claim 9, further comprising ranking the respective ratios from the plurality of respective quantified liquidity risk indicators to obtain ranked ratios.

11. The method of claim 10, wherein the ranking comprises ranking the respective ratios for each respective asset from the plurality of assets from at least one of a highest rank to a lowest rank and a lowest rank to a highest rank and wherein a rank is associated with a level of liquidity.

12. The method of claim 11, further comprising generating a set of respective liquidity risk scores for the respective assets based on the ranking.

13. The method of claim 12, wherein the ranking further comprises ranking the set of respective liquidity risk scores against the respective liquidity risk scores for at least one of the plurality of assets, a group of assets, a portfolio of assets, at least one asset in the same asset class, at least one asset within the same sector, at least one asset of the same issuer, and at least one asset with similar characteristics.

14. The method of claim 1, wherein the respective measurements of respective changes in liquidity of the respective assets are based on transaction data comprising one or more of a price measure for a respective asset from the plurality of assets, a volume measure for a respective asset from the plurality of assets, a time measure for a respective asset from the plurality of assets, a price of a respective asset from the plurality of assets, a bid price of a respective asset from the plurality of assets, an ask price of a respective asset from the plurality of assets, a bid time of a respective asset from the plurality of assets, an ask time of a respective asset from the plurality of assets, a bid volume of a respective asset from the plurality of assets, an ask volume of a respective asset from the plurality of assets, a quantity volume of a respective asset from the plurality of assets, a dollar amount volume of a respective asset from the plurality of assets, volume-weighted average price of a respective asset from the plurality of assets, a last sale price of a respective asset from the plurality of assets, a last sale time of a respective asset from the plurality of assets, a last sale volume of a respective asset from the plurality of assets, a plurality of transaction times for a respective asset from the plurality of assets, a plurality of transaction prices for a respective asset from the plurality of assets, a plurality of transaction volumes for a respective asset from the plurality of assets, and other data pertaining to a respective asset from the plurality of assets.

15. The method of claim 1, wherein a respective asset from the plurality of assets comprises one or more of an equity asset, a fixed income asset, a commodity asset, a currency asset, a synthetic asset, a crypto currency asset, a non-fungible token asset, an art asset, an exchange traded fund (ETF) asset, an exchange traded note (ETN) asset, a derivative asset, a swaps instrument asset, an option contract asset, an equity option contract asset, a futures contract asset, an exchange traded product (ETP) asset, and any other tradable asset.

16. The method of claim 5, further comprising generating a respective score for the respective ranked ratios to obtain respective scored quantified liquidity risk indicators.

17. The method of claim 1, wherein the aggregating comprises averaging the plurality of respective measurements of respective changes in liquidity of the respective assets from the plurality of assets to obtain an aggregated quantified indicator of liquidity risk for the portfolio.

18. The method of claim 1, wherein the aggregating comprises applying respective portfolio weights to the respective measurements of respective changes in liquidity of the respective assets from the plurality of assets to obtain an aggregated quantified indicator of liquidity risk for the portfolio.

19. The method of claim 1, wherein the monitoring the index over a period of time comprises (i) determining a point in time as a starting reference point for the index; (ii) assigning a value to the index corresponding to the starting reference point, and (iii) determining relative changes in the index over a period of time since the starting reference point based on performing a look-back basis.

20. The method of claim 1, wherein the index has a value within a bounded range of values between a minimum value and a maximum value.

21. A computer-implemented system for tracking aggregated quantified liquidity risk across a plurality of assets, the system comprising:
a processor configured to:
access data from a plurality of data sources including transactional data, wherein the transactional data comprises respective pricing information and reference data for respective assets in a plurality of assets;
measure, with a statistical process, a respective change in liquidity of each of the respective assets based on at least one of an estimated projected trade volume capacity of the respective asset, an estimated projected volatility of the respective asset, an estimated projected time to liquidate the respective asset, and an estimated projected cost to liquidate the respective asset to obtain respective measurements of respective changes in liquidity of the respective assets;
aggregate, at a portfolio level, the respective measurements of respective changes in liquidity of the respective assets to obtain an aggregated quantified indicator of liquidity risk for the portfolio, wherein the aggregated quantified indicator of liquidity risk has a value in a bounded range from 0 to 100, and wherein a higher value in the bounded range of the aggregated quantified indicator of liquidity risk indicates a higher projected level of liquidity of the portfolio as compared with a lower value in the bounded range; and
generate a display for a graphical user interface or a file of the aggregated quantified indicator of liquidity risk.
